(19) United States
(12) Patent Application Publication
(10) Pub. No.: US 2026/0359574 A1
(43) Pub. Date: Nov. 12, 2026

(54) Multi-Dimensional Comprehensive Text Identification Method

(71) Applicant: THE 10TH RESEARCH INSTITUTE OF CHINA ELECTRONICS TECHNOLOGY GROUP CORPORATION, Chengdu, Sichuan (CN)

(72) Inventors: Xiang GAO, Chengdu, Sichuan (CN); Ying CUI, Chengdu, Sichuan (CN); Xiang DAI, Chengdu, Sichuan (CN); Weiqing CHEN, Chengdu, Sichuan (CN); Jianjun HE, Chengdu, Sichuan (CN); Lei PAN, Chengdu, Sichuan (CN); Hongzhou LIAO, Chengdu, Sichuan (CN); Hongli DING, Chengdu, Sichuan (CN); Lican DAI, Chengdu, Sichuan (CN); Kan WANG, Chengdu, Sichuan (CN)

(21) Appl. No.: 19/124,881

(22) PCT Filed: Jul. 19, 2023
(86) PCT No.: PCT/CN2023/108226

§ 371 Date: Apr. 27, 2025

(30) Foreign Application Priority Data
Oct. 27, 2022 (CN) 202211324458.3

(51) Int. Cl. G06F 40/40; G06F 40/295

(52) U.S. Cl. CPC G06F 40/40; G06F 40/295

(57) ABSTRACT

Disclosed in the present disclosure is a multi-dimensional comprehensive text identification method. The method comprises: acquiring a text to be identified, and dividing same into a multiple segmented sentences; performing common-sense detection on the multiple segmented sentences, to obtain a first text authenticity probability and a common-sense conflict list; performing fact detection on the multiple segmented sentences, to obtain a second text authenticity probability and a fact conflict list; performing content detection on the multiple segmented sentences, to obtain a third text authenticity probability, and sentences and words supporting a determination result; and obtaining a comprehensive text identification result based on the first text authenticity probability, the second text authenticity probability and the third text authenticity probability.

The present disclosure claims priority to Chinese Patent Application No. 202211324458.3, to the China National Intellectual Property Administration on 27 Oct. 2022 and entitled “Multi-Dimensional Comprehensive Text Identification Method”, which is incorporated herein by reference in its entirety.

### TECHNICAL FIELD

The present disclosure relates to the technical field of text detection, and in particular, to a multi-dimensional comprehensive text identification method.

### BACKGROUND

With the continuous development of Internet and self-media technologies, we have entered an era of information explosion. While enjoying the convenience brought by the Internet and the pleasure brought by the self-media, people also suffer greatly from the troubles of fake news and rumors.

The fake news is generally divided into two major categories: the fake news synthesized by artificial intelligence and the fake news fabricated by human beings. Given the rapid development of large-scale pre-trained language models, generated by artificial intelligence has already achieved high fluency and readability, but it often contains often contains content that violates common sense. The fake news fabricated by human beings can avoid the case of violation of common-sense through human knowledge reserves, but it often contains content that violates factual accuracy. The existing fake text intelligent identification model is usually based on the text content itself, and does not have the capability of conflict detection and authenticity identification of common sense and facts. How to perform multi-dimensional comprehensive text identification by a series of knowledge, such as common sense and objective facts, is the problem to be solved urgently at present.

### SUMMARY

In view of the above, the present disclosure provides a multi-dimensional comprehensive text identification method, which can perform comprehensive identification on text content by objective knowledge and text content, such as a common-sense base and an event base.

The present disclosure provides a multi-dimensional comprehensive text identification method, including:
acquiring a text to be identified, and dividing the text to be identified into multiple segmented sentences;
performing common-sense detection on the multiple segmented sentences, to obtain a first text authenticity probability and a common-sense conflict list;
performing fact detection on the multiple segmented sentences, to obtain a second text authenticity probability and a fact conflict list;
performing content detection on the multiple segmented sentences, to obtain a third text authenticity probability, and sentences supporting a determination result and words supporting the determination result; and
obtaining a comprehensive text identification result based on the first text authenticity probability, the second text authenticity probability and the third text authenticity probability.

In an embodiment, the method further includes:
combining the common-sense conflict list, the fact conflict list, and the sentences supporting the determination result and the words supporting the determination result, and inputting same into an interpretable text generation model to obtain a comprehensive identification report.

In an embodiment, performing common-sense detection on the multiple segmented sentences, to obtain the first text authenticity probability and the common-sense conflict list includes:
extracting all common-sense knowledge in the multiple segmented sentences, to form a common-sense knowledge set, wherein the common-sense knowledge includes a head entity, a relation and a tail entity;
traversing starting from a first common-sense knowledge in the common-sense knowledge set, calculating similarity values between a combination of the head entity and the relation of a currently traversed common-sense knowledge and all the combinations of head entities the relations in a common-sense knowledge base respectively, to obtain first similarity values, and selecting a first maximum similarity value from the first similarity values;
determining, based on the first maximum similarity value and a first preset threshold, whether there is a common-sense knowledge matching the currently traversed common-sense knowledge in the common-sense knowledge base;
determining, based on a matched common-sense knowledge and a second preset threshold, whether there is a common-sense knowledge conflicting with the currently traversed common-sense knowledge in the common-sense knowledge base; and
outputting the first text authenticity probability and the common-sense conflict list until the determination of all the common-sense knowledge in the common-sense knowledge set is completed.

In an embodiment, determining, based on the first maximum similarity and a first preset threshold, whether there is the common-sense knowledge matching the currently traversed common-sense knowledge in the common-sense knowledge base includes:
comparing the first maximum similarity value with the first preset threshold;
in response to the first maximum similarity value being less than the first preset threshold, confirming that there is no common-sense knowledge matching the currently traversed common-sense knowledge in the common-sense knowledge base, taking the maximum similarity value as the first text authenticity probability, and outputting a note that there is no common-sense knowledge matching the currently traversed common-sense knowledge in the common-sense knowledge base;
after outputting the note that there is no common-sense knowledge matching the currently traversed common-sense knowledge in the common-sense knowledge base, the method further including:
manually determining whether the currently traversed common-sense knowledge is able to be accepted as credible; in response to the currently traversed common-sense knowledge being able to be accepted as credible, storing the currently traversed common-sense knowledge to the common-sense knowledge base; and
in response to the first maximum similarity being greater than or equal to the first preset threshold, then determining that there is common-sense knowledge matching the currently traversed common-sense knowledge in the common-sense knowledge base.

In an embodiment, determining, based on the matched common-sense knowledge and the second preset threshold, whether there is the common-sense knowledge conflicting with the currently traversed common-sense knowledge in the common-sense knowledge base includes:
calculating the similarity values between a triple of the matched common-sense knowledge in the common-sense knowledge base and the combination of the head entity, the relation and the tail entity of the currently traversed common-sense knowledge, to obtain second similarity values, and selecting a second maximum similarity value from the second similarity values;
comparing the second maximum similarity value with a second preset threshold;
in response to the second maximum similarity value being less than the second preset threshold, determining that there is a conflict between the currently traversed common-sense knowledge and the common-sense knowledge in the common-sense knowledge base, and outputting the maximum similarity value and the common-sense conflict list, the maximum similarity value being the first text authenticity probability; in response to the second maximum similarity value being greater than or equal to the second preset threshold, determining that the currently traversed common-sense knowledge does not conflict with the common-sense knowledge in the common-sense knowledge base.

In an embodiment, performing fact detection on the multiple segmented sentences, to obtain the second text authenticity probability and the fact conflict list includes:
extracting all the event sentences from the multiple segmented sentences, to form an event sentence set;
performing element extraction on each event sentence to obtain elements corresponding to each event sentence; wherein the elements including an event time, an event place, an event subject, an event object and an event trigger word;
traversing starting from a first event sentence of the event sentence set, and for the fact detection of a currently traversed event sentence, combining the currently traversed event sentence with corresponding elements thereof to serve as a text;
calculating the similarity values between the text and each event sentence in a domain event base, to obtain third similarity values, and selecting a maximum value from the third similarity values;
in response to the maximum value being less than a third preset threshold, outputting the maximum value as the second text authenticity probability, and making a note that there is no event matching the text in the domain event base;
in response to the maximum value being greater than or equal to the third preset threshold, calculating the similarity value between a text description of the text and a text description of the event sentence corresponding to the maximum value in the event sentence set, to obtain a target similarity value;
determining, based on the target similarity value and a fourth preset threshold, whether the text conflicts with an event sentence in the domain event base; and
outputting the second text authenticity probability and the fact conflict list until the fact detection of all event sentences in the event sentence set is completed.

In an embodiment, before calculating the similarity values between the text and each event sentence in a domain event base, and selecting a maximum value from the similarity values, the method further includes:
obtaining embedding representations corresponding to the text and all events in the domain event base by a pre-trained language model.

In an embodiment, determining, based on the target similarity value and the fourth preset threshold, whether the text conflicts with the event sentence in the field event base includes:
in response to the first similarity being greater than or equal to a fourth preset threshold, setting a confidence threshold, and when the fourth preset threshold is greater than the confidence threshold, determining the text as a high-confidence event, and adding the text to the domain event base; and
in response to the first similarity being less than the fourth preset threshold, determining that there is a conflict between the text and events in the domain event base, and outputting the fact conflict list and the target similarity value, the target similarity value being the second text authenticity probability.

In an embodiment, performing content detection on the multiple segmented sentences, to obtain the third text authenticity probability, and the sentences supporting the determination result and the words supporting the determination result includes:
performing keyword identification on the multiple segmented sentences respectively, to obtain an importance corresponding to each keyword;
ranking all the importance in a descending order to obtain an importance set;
recording a longest length of the input characters for fake text detection as len_max, and intercepting first u sentences in the importance set, a total number of characters of the first u sentences being recorded as charᵤ; and ensuring charᵤ≤len_max and charᵤ₊₁<len_max, in response to charₙ≤len_max, determining u=n;
inputting a new text composed of the first u sentences into the pre-trained language model for fake text detection, outputting a probability value of text authenticity, and outputting high-weight sentences and words supporting the determination result as a determination and explanation basis, the probability value of text authenticity being the third text authenticity probability.

In an embodiment, obtaining the comprehensive text identification result based on the first text authenticity probability, the second text authenticity probability and the third text authenticity probability includes:
multiplying the first text authenticity probability, the second text authenticity probability and the third text authenticity probability respectively with corresponding weights, and summing all multiplication results to obtain a comprehensive text identification result; wherein a sum of all weights being equal to 1.

Due to the adoption of the described solution, the present disclosure has the following effects: by the multi-dimensional comprehensive text identification method proposed in the present disclosure, the present disclosure can not only perform full-dimensional comprehensive identification on texts in terms of common-sense conformity, fact conformity and text content, but can also perform interpretability analysis on an identification result, to present the result in the form of a comprehensive identification report.

### BRIEF DESCRIPTION OF THE DRAWINGS

To describe the solutions in the present disclosure more clearly, the following briefly describes the accompanying drawings required for describing the embodiments. Apparently, the accompanying drawings in the following description show merely some embodiments of the present disclosure, and a person of ordinary skill in the art may still derive other accompanying drawings from these accompanying drawings.

FIG. 1 is a schematic diagram of the principle of a multi-dimensional comprehensive text identification method according to an embodiment of the present disclosure;

FIG. 2 is a schematic flowchart of the principle of common-sense detection according to an embodiment of the present disclosure;

FIG. 3 is a schematic flowchart of the principle of fact detection according to an embodiment of the present disclosure.

### DETAILED DESCRIPTION OF THE EMBODIMENTS

The present disclosure is further described with reference to the accompanying drawings and embodiments. Obviously, the embodiments as described are only parts of embodiments rather than all the embodiments of the present disclosure. All other embodiments obtained by a person of ordinary skill in the art shall all fall within the scope of protection of the embodiments of the present disclosure.

The present disclosure provides a multi-dimensional comprehensive text identification method, which is mainly composed of four parts: common-sense detection, fact detection, content detection and comprehensive identification. A text to be identified is firstly segmented into sentences based on punctuation marks such as a full stop, a question mark and an exclamation mark, and then the sentence sets are respectively sent to a common-sense detection module, a fact detection module and a content detection module.

The common-sense detection module includes several processes of common-sense sentence recognition, common-sense extraction and common-sense conflict detection. The common-sense detection module can detect the common-sense coincidence condition of the text based on the constructed common-sense knowledge base. Common-sense sentence recognition is first performed on the segmented sentence sets; the common-sense sentence recognition module is a binary classification; after training with a large number of corpora, the module can determine a text on which sentence segmentation has been performed; and in response to the text contains common sense knowledge, the text is considered to be a common-sense sentence; then common-sense extraction is performed on the common-sense sentence; the common-sense extraction module can extract subject, object and relation words from the common-sense sentence; and the extracted domain common sense can be represented in the form of a triplet.

The common-sense knowledge base stores a large amount of proven high-confidence domain common-sense knowledge in the form of a knowledge graph, is a data base of the common-sense detection module, and can grow dynamically based on practical requirements. The common-sense conflict detection module can compare common-sense knowledge extracted from the common-sense sentence with high-confidence common-sense knowledge stored in the common-sense knowledge base to detect conflict items; the conflict items are divided into two types, one type are those not matching the content of the common-sense knowledge base, and the other type are those not existing in the common-sense knowledge base. And the common-sense conflict detection module defines different authenticity weights for the two types, and quantitatively outputs a common-sense detection result and a conflict item list.

Since the common-sense knowledge base may be incomplete, in cases where the extracted common-sense knowledge does not exist in the common-sense knowledge base, further confirmation is performed, and in response to the confidence of the extracted common-sense knowledge is very high, the common-sense knowledge is added to the common-sense knowledge base for the next common-sense detection.

The fact detection module includes several processes of event sentence recognition, event element extraction and fact conflict detection. The fact detection module can detect the fact compliance of the text on the basis of the constructed domain event base. Common-sense sentence recognition is first performed on the segmented sentence sets; the event sentence recognition module is a binary classification; after training with a large number of corpora, the module can determine a text on which sentence segmentation has been performed.

In response to core elements, such as an event time, an event place, an event subject, an event object and an event trigger word, are contained, the text is considered as an event sentence; then event element extraction is performed on the event sentence, and the event element extraction module can extract event elements, such as a subject, an object, an occurrence time, an occurrence location and a trigger word, in the event sentence. The domain event base stores a large number of proven high-confidence domain events, each domain event containing elements such as an event time, an event location, an event subject, an event object and an event trigger word, is the data basis of the fact detection module, and can dynamically grow over time.

The event conflict detection module can compare an element extracted from the event sentence with a high-confidence event stored in the domain event base at an element level for detection to find a conflict item, and quantitatively output an event detection result and a conflict item list. Since events are a special type of data that continuously evolves over time, it is essential to store high-confidence event data in the base. Before fact detection is performed, a confidence threshold is first preset. And after detecting, the event sentences, of which the authenticity is higher than the confidence threshold, and the event elements are added to the domain event base for the next fact detection.

The content detection module includes several processes of key sentence recognition and fake text detecting. The content detection module does not need the support from external database, and only performs fake detection on the text content. Since the existing artificial intelligence deep learning-based falsity detection model has a limitation on the length of an input text character, it is not realistic to perform falsity identification the full text of on a long text. On the other hand, a single sentence in the text cannot represent the essence of the whole text, and it is not sufficient to perform falsity identification on the single sentence. The present disclosure proposes that before performing text falsity identification, key sentence recognition is performed first; and a key sentence recognition module is a regression model that, after being trained by a large number of corpora, can evaluate the importance of the segmented text and output an importance score ranging from 0 to 1. Then key sentences are sorted based on the key scores; within the longest input character length limitation of false identification, by taking a list of top-ranked key sentences and the score values corresponding thereto as an input, a text with an appropriate character length is reorganized, and is sent to the Fake text detection module. The Fake text detection module is a binary classification model which, after being trained by a large amount of corpus, can determine the authenticity of a text, and quantitatively output a content detection result and high-weight words supporting the detection result.

The comprehensive identification module can take a common-sense detection result, a fact detection result and a content detection result as inputs to perform multi-dimensional comprehensive identification of the text to be identified. The common-sense detection result, the fact detection result and the content detection result all contain two aspects, one is a quantitative authenticity identification result with an interval of [0-1], and the other is interpretable information. The comprehensive identification module is composed of a comprehensive identification result calculation module and an interpretable text generation module. The comprehensive identification result calculation module performs weighted averaging on three parts of the quantitative authenticity identification result to obtain a comprehensive quantitative identification result with an interval of [0-1]. The interpretable text generation module can generate a highly readable comprehensive identification report by means of a deep learning-based text generation model using the interpretable information outputted from the three detection modules.

The comprehensive identification module generates a comprehensive identification conclusion by calculation, the comprehensive identification conclusion being composed of a comprehensive quantitative identification result and a comprehensive identification report.

For ease of understanding, the present disclosure provides a more specific embodiment:

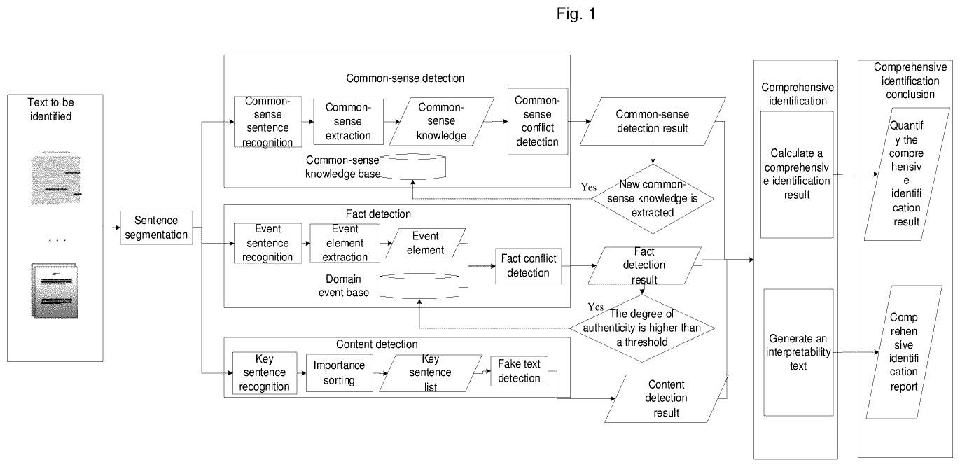

Referring to FIG. 1, the present disclosure provides an embodiment of a multi-dimensional comprehensive text identification method, including:
first, based on punctuation marks, segmenting a text into n sentences, and representing a sentence segmentation result by a set S={s1, s2, . . . , sn}.

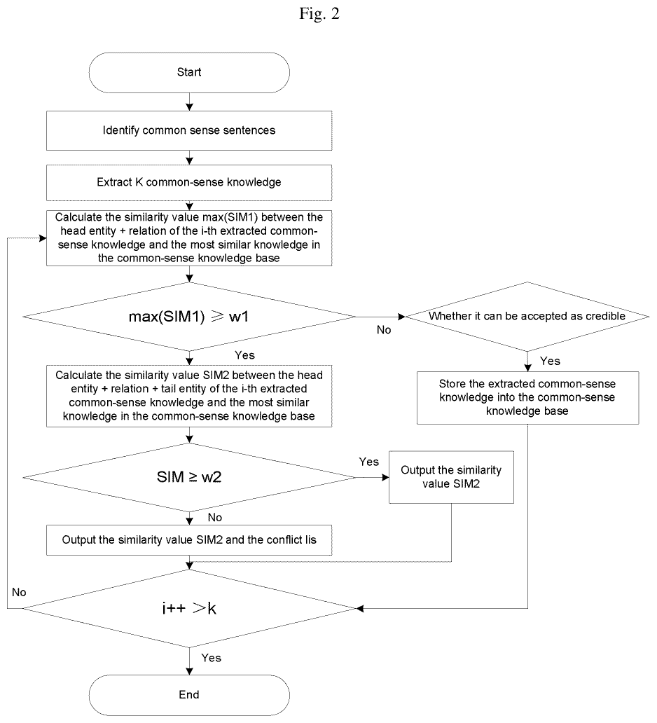

### 1. General Sense Detection, See FIG. 2:

Step 1.1: common-sense sentence recognition is performed on S to obtain m common sense sentences, m≤n.
Step 2.1: common-sense extraction is performed on m common-sense sentences to obtain k pieces of common-sense knowledge, which are represented as a set C={c1, c2, . . . , ck}, where ci=(hi, ri, ti), hi being the head entity of common sense ci, ri being the relation of the common sense ci, and ti being the tail entity of the common sense ci.
Step 3.1: the combination of hi+ri of ci is respectively traversed and compared with the combination of the head header entity+the relation in the common-sense knowledge base, to calculate the similarity values. Assuming that there are always p common senses in the common-sense knowledge base, a similarity value set SIM1={sim1, sim2, . . . , simp} is obtained. Setting a threshold w1, when max (SIM1)<w1, it is considered that there is no common sense matching the extracted common sense in the detection common-sense base; max (SIM1) is outputted as a result of the quantitative common-sense detection, and furthermore, a note that the common sense has no matching in the common-sense base is outputted;

In this case, it is further determined manually whether the common sense is able to be accepted as credible, and in response to the currently traversed common-sense knowledge being able to be accepted as credible, the common sense is added to the common-sense knowledge base for use in the next common-sense detection.
when max (SIM1)≥w1, it is considered that a matched common sense is found in the common-sense knowledge base. The index of max (SIM1) is found; the similarity value between the triple of the common sense in the common-sense base and hi+ri+ti is calculated to obtain SIM2; and SIM2 is output as a result of the quantitative common-sense detection. Setting a threshold w2, when SIM2<w2, it is considered that ci conflicts with common sense in the common-sense base, and conflict items are outputted; when SIM2≥w2, it is considered that ci does not conflict with the knowledge in the common-sense base.
Step 4.1: step 3.1 is repeated until all of k common-sense knowledge are traversed.

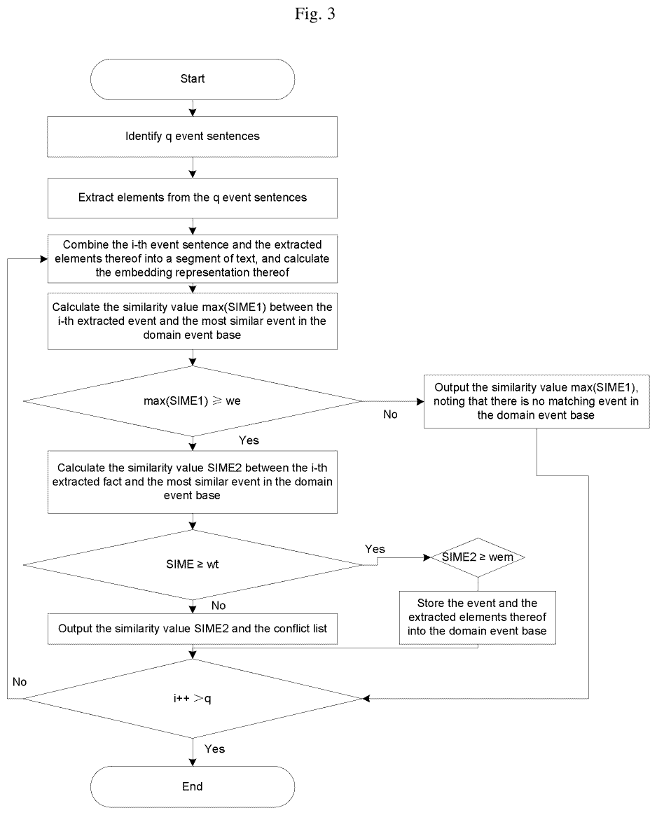

### 2) Fact Detection, as Shown in FIG. 3:

Step 1.2: event sentence recognition is performed on S to obtain q event sentences, which are denoted as E={e1, e2, . . . , eq}, q≤n.
Step 2.2: event elements are extracted from the q event sentences, the event elements including an event time, an event location, an event subject, an event object, and an event trigger word.
Step 3.2: the sentence itself of ei and the extracted event elements are combined together to form a segment of new text. An embedding representation of the segment of new text is obtained by a BERT model. An embedding representation of each event in the domain event base is obtained by a unified method.
   The domain event base is traversed to calculate similarity values between ei and each event in the domain event base. Assuming that there are always u events in the domain event base, a similarity value set SIME1={sime1, sime2, . . . , simeu} is obtained. Setting a threshold we. when max (SIME1)<we, it is considered that there is no event matching the ei description in the domain event base, and max (SIME1) is outputted as a result of the quantitative fact detection; in this case, a note that the event has no matching in the domain event base is outputted.

When max (SIME1)≥we, it is considered that a matching event is found in a domain event base, an index of max (SIME) is found, a text description of the event is acquired, and a text conflict detection is performed on both the text description of the event and the text description of ei. A fact compliance degree SIME2 of ei is calculated; setting a threshold wt, when SIME2<wt, it is considered that ei conflicts with the facts in the domain event base, and a conflict items are output.

When SIME2≥wt, it is considered that ei does not conflict with the facts in the domain event base. Setting a confidence threshold wem, when SIME2>wem, it is considered that the event is a high-confidence event, and the event is added to the domain event base.
Step 4.2: step 3.2 is repeated until all q event sentences are traversed.

### 3) Content Detection

Step 1.3: keyword sentence recognition is performed on S to obtain the importance of n sentences, which are recorded as Im={im1, im2, . . . , imn}.
Step 2.3: the Im is sorted in a descending order.
Step 3.3: the longest length of the input characters for fake text detection is set as len_max. The first u sentences sorted based on the importance are intercepted; the total number of the characters of the first u sentences is recorded as charᵤ; and it is ensured that charᵤ≤len_max and charᵤ₊₁<len_max, in response to charₙ≤len_max, u=n is determined.
Step 4.3: a new text formed by u re-sorted sentence lists is inputted into a BERT model for fake detection; a probability value of text authenticity is output; and high-weight sentences and words supporting the determination result are further outputted as a determination and explanation basis.

### 4) Comprehensive Identification

Assuming that the common-sense detection module outputs a text authenticity probability P1, and the common-sense conflict list is C1; the fact detection module outputs a text authenticity probability P2, and the fact conflict list is C2; the content detecting module outputs a text authenticity probability P3, and the high-weight sentences and words supporting the determination result are represented as C3.
Step 1.4: a comprehensive identification result, P=Wg1×P1+Wg2×P2+Wg3×P3 is calculated, wherein Wg1, Wg2 and Wg3 respectively represent weights corresponding to output values of three detection models, it is satisfied that

$${\sum }_{i = 1}^{i = 3} {W}_{gi} = 1 ;$$

and the weight values of different detection modules can be adjusted flexibly based on specific service requirements.
Step 2.4: C1, C2 and C3 are combined together and inputted into the interpretable text generation model to generate a comprehensive identification report.

Finally, it should be noted that the described embodiments are only used to explain the technical solutions in some embodiments of the present disclosure, rather than limit same. Although the present disclosure is described in detail with reference to the foregoing embodiments, those of ordinary skill in the art should understand that modifications or equivalent replacements can still be made to the specific embodiments of the present disclosure, any modification or equivalent replacement without departing from the spirit and scope of the present disclosure shall fall within the scope of protection of the claims of the present disclosure.

What is claimed is:

1. A multi-dimensional comprehensive text identification method, comprising:
acquiring a text to be identified, and dividing the text to be identified into multiple segmented sentences;
performing common-sense detection on the multiple segmented sentences, to obtain a first text authenticity probability and a common-sense conflict list;
performing fact detection on the multiple segmented sentences, to obtain a second text authenticity probability and a fact conflict list;
performing content detection on the multiple segmented sentences, to obtain a third text authenticity probability, and sentences supporting a determination result and words supporting the determination result; and
obtaining a comprehensive text identification result based on the first text authenticity probability, the second text authenticity probability and the third text authenticity probability.

2. The method as claimed in claim 1, the method further comprising:
combining the common-sense conflict list, the fact conflict list, the sentences supporting the determination result and the words supporting the determination result, and inputting same into an interpretable text generation model to obtain a comprehensive identification report.

3. The method as claimed in claim 1, wherein performing common-sense detection on the multiple segmented sentences, to obtain the first text authenticity probability and the common-sense conflict list comprises:
extracting all common-sense knowledge from the multiple segmented sentences, to form a common-sense knowledge set, wherein the common-sense knowledge comprises a head entity, a relation and a tail entity;
traversing starting from a first common-sense knowledge in the common-sense knowledge set, calculating similarity values between a combination of the head entity and the relation of a currently traversed common-sense knowledge and all the combinations of head entities and relations in a common-sense knowledge base respectively, to obtain first similarity values, and selecting a first maximum similarity value from the first similarity values;
determining, based on the first maximum similarity value and a first preset threshold, whether there is a common-sense knowledge matching the currently traversed common-sense knowledge in the common-sense knowledge base;
determining, based on a matched common-sense knowledge and a second preset threshold, whether there is a common-sense knowledge conflicting with the currently traversed common-sense knowledge in the common-sense knowledge base; and
outputting the first text authenticity probability and the common-sense conflict list until the determination of all the common-sense knowledge in the common-sense knowledge set is completed.

4. The method as claimed in claim 3, wherein determining, based on the first maximum similarity value and the first preset threshold, whether there is the common-sense knowledge matching the currently traversed common-sense knowledge in the common-sense knowledge base comprises:
comparing the first maximum similarity value with the first preset threshold;
in response to the first maximum similarity value being less than the first preset threshold, confirming that there is no common-sense knowledge matching the currently traversed common-sense knowledge in the common-sense knowledge base, taking the maximum similarity value as the first text authenticity probability, and outputting a note that there is no common-sense knowledge matching the currently traversed common-sense knowledge in the common-sense knowledge base;
after outputting the note that there is no common-sense knowledge matching the currently traversed common-sense knowledge in the common-sense knowledge base, the method further comprising:
manually determining whether the currently traversed common-sense knowledge is able to be accepted as credible; in response to the currently traversed common-sense knowledge being able to be accepted as credible, storing the currently traversed common-sense knowledge to the common-sense knowledge base; and
in response to the first maximum similarity value being greater than or equal to the first preset threshold, determining that there is common-sense knowledge matching the currently traversed common-sense knowledge in the common-sense knowledge base.

5. The method as claimed in claim 4, wherein determining, based on the matched common-sense knowledge and the second preset threshold, whether there is the common-sense knowledge conflicting with the currently traversed common-sense knowledge in the common-sense knowledge base comprises:
calculating the similarity values between a triple of the matched common-sense knowledge in the common-sense knowledge base and the combination of the head entity, the relation and the tail entity of the currently traversed common-sense knowledge, to obtain second similarity values, and selecting a second maximum similarity value from the second similarity values;
comparing the second maximum similarity value with a second preset threshold;
in response to the second maximum similarity value being less than the second preset threshold, determining that there is a conflict between the currently traversed common-sense knowledge and the common-sense knowledge in the common-sense knowledge base, and outputting the maximum similarity value and the common-sense conflict list, the maximum similarity value being the first text authenticity probability;
in response to the second maximum similarity value being greater than or equal to the second preset threshold, determining that the currently traversed common-sense knowledge does not conflict with the common-sense knowledge in the common-sense knowledge base.

6. The method as claimed in claim 1, wherein performing fact detection on the multiple segmented sentences, to obtain the second text authenticity probability and the fact conflict list comprises:
extracting all the event sentences from the multiple segmented sentences, to form an event sentence set;
performing element extraction on each event sentence to obtain elements corresponding to each event sentence; wherein the elements comprising an event time, an event place, an event subject, an event object and an event trigger word;
traversing starting from a first event sentence of the event sentence set, and for the fact detection of a currently traversed event sentence, combining the currently traversed event sentence with corresponding elements thereof to serve as a text;
calculating the similarity values between the text and each event sentence in a domain event base, to obtain third similarity values, and selecting a maximum value from the third similarity values;
in response to the maximum value being less than a third preset threshold, outputting the maximum value as the second text authenticity probability, and making a note that there is no event matching the text in the domain event base;
in response to the maximum value being greater than or equal to the third preset threshold, calculating the similarity value between a text description of the text and a text description of the event sentence corresponding to the maximum value in the event sentence set, to obtain a target similarity value;
determining, based on the target similarity value and a fourth preset threshold, whether the text conflicts with an event sentence in the domain event base; and
outputting the second text authenticity probability and the fact conflict list until the fact detection of all event sentences in the event sentence set is completed.

7. The method as claimed in claim 6, wherein before calculating the similarity values between the text and each event sentence in a domain event base, and selecting a maximum value from similarity values, the method further comprises:
obtaining embedding representations corresponding to the text and all events in the domain event base by a pre-trained language model.

8. The method as claimed in claim 6, wherein determining, based on the target similarity value and the fourth preset threshold, whether the text conflicts with the event sentence in the field event base comprises:
in response to the target similarity value being greater than or equal to a fourth preset threshold, setting a confidence threshold, and when the fourth preset threshold is greater than the confidence threshold, determining the text as a high-confidence event, and adding the text to the domain event base; and
in response to the target similarity value being less than the fourth preset threshold, determining that there is a conflict between the text and events in the domain event base, and outputting the fact conflict list and the target similarity value, the target similarity value being the second text authenticity probability.

9. The method as claimed in claim 1, wherein performing content detection on the multiple segmented sentences, to obtain the third text authenticity probability, and the sentences supporting the determination result and the words supporting the determination result comprises:
performing keyword identification on the multiple segmented sentences respectively, to obtain an importance corresponding to each keyword;
ranking all the importance in a descending order to obtain an importance set;
recording a longest length of the input characters for fake text detection as len_max, and intercepting first u sentences in the importance set, a total number of characters of the first u sentences being recorded as charᵤ; and ensuring charᵤ≤len_max and charᵤ₊₁<len_max;
in response to charₙ≤len_max, determining u=n;
inputting a new text composed of the first u sentences into the pre-trained language model for fake text detection, outputting a probability value of text authenticity, and outputting high-weight sentences and words supporting the determination result as a determination and explanation basis; the probability value of text authenticity being the third text authenticity probability.

10. The method as claimed in claim 1, wherein obtaining the comprehensive text identification result based on the first text authenticity probability, the second text authenticity probability and the third text authenticity probability comprises:
multiplying the first text authenticity probability, the second text authenticity probability and the third text authenticity probability respectively with corresponding weights, and summing all multiplication results to obtain a comprehensive text identification result; wherein a sum of all weights being equal to 1.
